(19) United States
(12) Patent Application Publication
(10) Pub. No.: US 2026/0069984 A1
(43) Pub. Date: Mar. 12, 2026

(54) SYSTEMS, APPARATUSES, METHODS, AND NON-TRANSITORY COMPUTER-READABLE STORAGE DEVICES FOR COLLABORATION BETWEEN DIGITAL CONTENT CREATORS AND GAME ENGINES

(71) Applicant: HUAWEI TECHNOLOGIES CO., LTD., Shenzhen (CN)

(72) Inventors: Shunguang DING, White Rock (CA); Ziyue Xie, Kanata (CA); Xiaoqiang Zhe, Shanghai (CN); Abhishek Sahir Nair, Kanata (CA); Xingjian Huang, Kanata (CA); Ayaskant Panigrahi, Kanata (CA); Bikram Adhikari, Kanata (CA); Gurjeet Atwal, Kanata (CA); Mahdi Davoodikakhki, Port Coquitlam (CA); Shixiong Gao, Kanata (CA)

(21) Appl. No.: 19/286,486

(22) Filed: Jul. 31, 2025

Related U.S. Application Data
(63) Continuation of application No. PCT/CN2023/073947, filed on Jan. 31, 2023.

(51) Int. Cl. A63F 13/63; A63F 13/35

(52) U.S. Cl. CPC A63F 13/63; A63F 13/35

(57) ABSTRACT

A method has the steps of: receiving at least one layer of a 3D model, broadcasting notification to one or more computing devices for notifying the one or more computing devices an update of the at least one layer of the 3D model, receiving a pull request from at least one of the one or more computing devices for pulling the at least one layer of the 3D model, and sending the at least one layer of the 3D model to the at least one of the one or more computing devices. The at least one of the one or more computing devices may then update the 3D model in its local storage using the received at least one layer.

### CROSS-REFERENCE TO RELATED APPLICATION

This application is a continuation of PCT International Patent Application Serial No. PCT/CN2023/073947 filed on Jan. 31, 2023, the content of which is incorporated herein by reference in its entirety.

### TECHNICAL FIELD

The present disclosure relates generally to systems, apparatuses, methods, and non-transitory computer-readable storage devices for online gaming, and in particular to systems, apparatuses, methods, and non-transitory computer-readable storage devices for collaboration between digital content creators and game engines.

### BACKGROUND

With the growth of online gaming, there is an increasing trend for three-dimensional (3D) modeling tools and game engine to transfer data and communicate with each other. However, online gaming often requires frequently transferring a large amount of data, data sharing and collaboration in online gaming is often inefficient thereby causing unsatisfactory experiences to users. For example, it may take too long to share 3D assets and it may have to be done manually. As to collaboration, it may take many steps to set up the environment, prepare 3D assets, and adjust the scenes as a team.

Some existing tools may export and import 3D files through the local workstation's file system. However, there may not be an existing product for exporting and importing data through the cloud between digital content creator (DCC) and game engine systems. Consequently, graphics changes may not be displayed on user's screen in real-time.

### SUMMARY

According to one aspect of this disclosure, there is provided a first method comprising: receiving data of at least one first layer of a three-dimensional (3D) model; broadcasting notification to one or more computing devices for notifying the one or more computing devices an update of the 3D model; receiving a pull request from at least one of the one or more computing devices for pulling the at least one first layer of the 3D model; and sending the at least one first layer of the 3D model to the at least one of the one or more computing devices.

In some embodiments, said sending the at least one first layer of the 3D model to the at least one of the one or more computing devices comprises: sending the entire 3D model to the at least one of the one or more computing devices.

In some embodiments, the 3D model comprises: at least one first file associated with the at least one first layer; and a second file comprising information of the at least one first layer and the at least one first file.

In some embodiments, the information of the at least one first layer comprises: a name of the at least one first layer; and a path of the at least one first file.

In some embodiments, the second file further comprises information of a second layer; and the information of the second layer comprises: a name of the second layer, and at least one reference pointing to the at least one first layer.

In some embodiments, the name of the second layer is a predefined name or an empty name.

In some embodiments, the 3D model comprises the second layer; and the information of the second layer comprises: a path of a third file associated with the second layer.

In some embodiments, the 3D model comprises: one or more third layers associated with the at least one first layer; the information of the at least one first layer comprises: one or more references each pointing to a respective third layer; and the information of the second layer comprises: one or more names of the one or more third layers, and one or more paths pointing to one or more third files associated with the one or more third layers.

According to one aspect of this disclosure, there is provided one or more processors for executing instructions stored in one or more non-transitory computer-readable storage devices to perform the above-described first method.

According to one aspect of this disclosure, there is provided one or more non-transitory computer-readable storage devices comprising computer-executable instructions, wherein the instructions, when executed, cause one or more processors to perform above-described first method.

According to one aspect of this disclosure, there is provided a second method comprising: storing information of a first layer of a three-dimensional (3D) model into a root file as a first informative data item; and storing, in a root informative data item of the root file, a first reference pointing to the first informative data item; the first informative data item comprises: a name of the first layer, and a path of a first file associated with the first layer.

In some embodiments, the root informative data item comprises: a predefined name or an empty name; and a field for storing the first reference.

In some embodiments, the root informative data item is associated with a file of a root layer of the 3D model; and the root informative data item further comprises: a path of the file of the root layer.

In some embodiments, the second method further comprises: storing information of a second layer of a three-dimensional (3D) model into the root file as a second informative data item; and storing, in the first informative data item, a second reference pointing to the second informative data item; wherein the second informative data item comprises: a name of the second layer, and a path of a second file associated with the second layer.

In some embodiments, the second method further comprises: changing the name of the first layer in the first informative data item.

In some embodiments, the second method further comprises: changing, in the first informative data item, the path of the first file associated with the first layer.

In some embodiments, the second method further comprises: removing the first informative data item from the root file; and removing the first reference from the root informative data item of the root file.

In some embodiments, the second method further comprises: determining that a push flag of the 3D model is set; and transmitting the 3D model to a computing device.

In some embodiments, the second method further comprises: determining that a push flag of the first layer of the 3D model is set; and transmitting the first layer of the 3D model to a computing device.

In some embodiments, the second method further comprises: determining that a pull flag of the first layer of the 3D model is set; downloading a third file from a computing device; and changing, in the first informative data item, the path of the first file to a path of the third file.

According to one aspect of this disclosure, there is provided one or more processors for executing instructions stored in one or more non-transitory computer-readable storage devices to perform the above-described second method.

According to one aspect of this disclosure, there is provided one or more non-transitory computer-readable storage devices comprising computer-executable instructions, wherein the instructions, when executed, cause one or more processors to perform the above-described second method.

The above-described methods, one or more processors, and one or more non-transitory computer-readable storage devices may be used for live-sync between a plurality of computing devices with increased production efficiency of digital arts. More specifically, the above-described systems, apparatuses, methods, and non-transitory computer-readable storage devices may provide many benefits such as:
By using the live-sync methods disclosed herein, transformations made to a 3D model such as translation, scaling, rotating, stretching, skewing, adding, deleting, material changes, texture changes, and/or the like made to one or more objects vertices, edges, faces, and/or the like of the 3D model may be automatically synchronized among various computing devices in real time. Such a live-sync may be built from its atomic level of translating, scaling, rotating of the object or objects, the vertices, edges, faces, or changing the material and texture, to a more augmented operation, thereby reducing manual operations of transferring 3D models while achieving real-time updating of the 3D models at different endpoints.
By using a suitable data structure that uses a root file and a plurality of 3D model template files, live synchronization may be achieved in a multi-layered fashion. As data of each layer may be stored separately (for example, in a separate 3D model template file) while the information of the 3D model is stored in a centralized location (for example, in the root file), the editing made by different users may be well separated by letting each user edit a separate layer, thereby facilitating multiuser collaboration on the same 3D model.
The push and pull operations and the push and pull flags disclosed herein may allow collaboration to be done asynchronously while having the option of synchronous collaboration using live-sync. The push and pull flags may disallow changes to be made to the same layer at the same time, thereby preventing ambiguity that may otherwise occur.

### BRIEF DESCRIPTION OF THE DRAWINGS

For a more complete understanding of the disclosure, reference is made to the following description and accompanying drawings, in which:

FIG. 1 is a schematic diagram of a computer network system, according to some embodiments of this disclosure;

FIG. 2 is a schematic diagram showing a simplified hardware structure of a computing device of the computer network system shown in FIG. 1;

FIG. 3 a schematic diagram showing a simplified software architecture of a computing device of the computer network system shown in FIG. 1;

FIG. 4 is a schematic diagram showing the function structure of the computer network system shown in FIG. 1 for 3D-model sharing and collaboration between various computing devices thereof, according to some embodiments of this disclosure;

FIG. 5 is a schematic diagram showing the detailed functional structure of the computer network system shown in FIG. 1, according to some embodiments of this disclosure;

FIG. 6 is a schematic diagram showing the data structure of a 3D model according to some embodiments of this disclosure, wherein the broken-line arrows point to the details of the fields indicated by the corresponding starting dots;

FIG. 7 is a schematic diagram showing the add-layer operation for adding a new top-level layer “Collection 4” to the root layer of the data structure of a 3D model as shown in FIG. 6, according to some embodiments of this disclosure;

FIG. 8 is a schematic diagram showing the add-sublayer operation for adding a new layer “Collection 5” to a layer of the data structure of a 3D model as shown in FIG. 6, according to some embodiments of this disclosure;

FIG. 9 is a schematic diagram showing the rename-layer operation for renaming an existing layer of the data structure of a 3D model as shown in FIG. 6, according to some embodiments of this disclosure;

FIG. 10 is a schematic diagram showing the edit-layer operation for editing the informative data item of an existing layer of the data structure of a 3D model as shown in FIG. 6, according to some embodiments of this disclosure;

FIG. 11 is a schematic diagram showing the delete-layer operation for deleting an existing layer of the data structure of a 3D model as shown in FIG. 6, according to some embodiments of this disclosure;

FIG. 12 is a schematic diagram showing the data structure of a 3D model according to some embodiments of this disclosure, wherein the data structure does not comprise a root layer;

FIG. 13 is a flowchart showing the workflow of the push operation for sending a 3D model from a client computing-device of the computer network system shown in FIG. 1 to the data-storage server thereof;

FIG. 14 is a flowchart showing the workflow of the pull operation for downloading one or more 3D models from the data-storage server of the computer network system shown in FIG. 1;

FIG. 15 is a flowchart showing the workflow of the object-level live-sync operation for synchronizing 3D models in real-time between various computing devices of the computer network system shown in FIG. 1; and

FIG. 16 is a flowchart showing the workflow of the layer-level live-sync operation for synchronizing one or more layers of a 3D model in real-time between various computing devices of the computer network system shown in FIG. 1.

### DETAILED DESCRIPTION

### A. System Structure

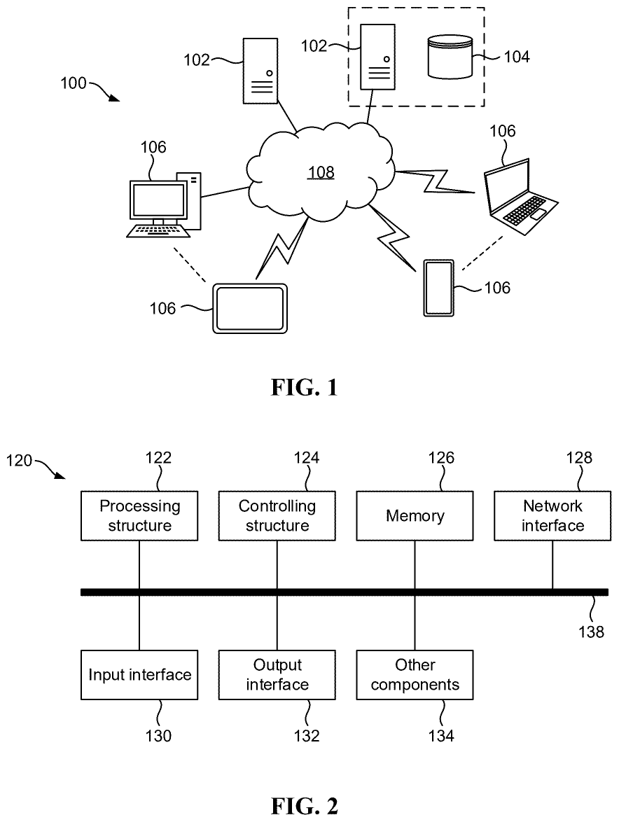

Turning now to FIG. 1, a computer network system is shown and is generally identified using reference numeral 100. As shown, the computer network system 100 comprises one or more server computers 102 maintaining a database 104 of graphics objects, one or more client computing-devices 106, all functionally interconnected by a network 108, such as the Internet, a local area network (LAN), a wide area network (WAN), a metropolitan area network (MAN), and/or the like, via suitable wired and wireless networking connections, for communication therebetween through the network 108. Some client computing-devices 106 may also directly communicate with each other without going through the network 108.

The server computers 102 may be computing devices designed specifically for use as a server, and/or general-purpose computing devices acting server computers while also being used by various users. Each server computer 102 may execute one or more server programs.

The client computing-devices 106 may be portable and/or non-portable computing devices such as laptop computers, tablets, smartphones, Personal Digital Assistants (PDAs), desktop computers, and/or the like. Each client computing-device 106 may execute one or more client application programs which sometimes may be called “apps”.

Generally, the computing devices 102 and 106 comprise similar hardware structures such as the hardware structure 120 shown in FIG. 2. As shown, the hardware structure 120 comprises a processing structure 122, a controlling structure 124, one or more non-transitory computer-readable memory or storage devices 126, a network interface 128, an input interface 130, and an output interface 132, functionally interconnected by a system bus 138. The hardware structure 120 may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), μ-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes or procedures, as the design purpose and/or the use case maybe. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processings thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 102) may be implemented using other technologies such as analog technologies.

Referring back to FIG. 2, the controlling structure 124 comprises one or more controlling circuits, such as graphic controllers, input/output chipsets and the like, for coordinating operations of various hardware components of the computing device 102/106.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more networking circuits for connecting to other computing devices or networks through the network 108 by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input circuits, components, and/or devices for one or more users to input data via, for example, touch-sensitive screen, touch-sensitive whiteboard, touch-pad, keyboards, computer mouse, trackball, microphone, scanners, cameras, and/or the like. The input interface 130 may be a physically integrated part of the computing device 102/106 (for example, the touch-pad of a laptop computer or the touch-sensitive screen of a tablet), or may be a device physically separate from, but functionally coupled to, other components of the computing device 102/106 (for example, a computer mouse). The input interface 130, in some implementation, may be integrated with a display output to form a touch-sensitive screen or touch-sensitive whiteboard.

The output interface 132 comprises one or more output circuits, components, and/or devices for output data to a user via, for example, displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/106 (for example, the display of a laptop computer or tablet), or may be a device physically separate from but functionally coupled to other components of the computing device 102/106 (for example, the monitor of a desktop computer).

The computing device 102/106 may also comprise other components 134 such as one or more positioning circuits and/or devices, temperature sensors, barometers, inertial measurement unit (IMU), and/or the like.

The system bus 138 interconnects various components 122 to 134 enabling them to transmit and receive data and control signals to and from each other.

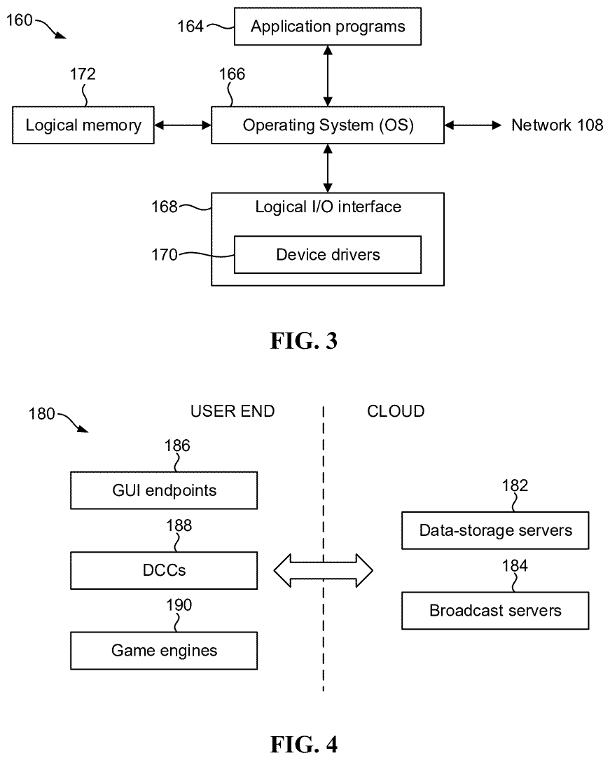

FIG. 3 shows a simplified software architecture 160 of the computing device 102 or 106. The software architecture 160 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 102 or 106 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like. The computing devices 102 and 106 of the computer network system 100 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the one or more application programs 164 generally provide server functions for managing network communication with client computing-devices 106 and facilitating collaboration between the server computer 102 and the client computing-devices 106. Herein, the term “server” may refer to a server computer 102 from a hardware point of view or a logical server from a software point of view, depending on the context.

As described above, the processing structure 122 is usually of no use without meaningful firmware and/or software. Similarly, while a computer system such as the computer network system 100 may have the potential to perform various tasks, it cannot perform any tasks and is of no use without meaningful firmware and/or software. As will be described in more detail later, the computer network system 100 described herein and the circuitries, and components thereof, as a combination of hardware and software, generally produces tangible results tied to the physical world, wherein the tangible results such as those described herein may lead to improvements to the computer devices and systems themselves, the circuitries and components thereof, and/or the like.

Embodiments disclosed herein may relate to one or more modules. As those skilled in the art will appreciate, the term “module” generally refers to a function block of a component, device, apparatus, system, and/or the like. In other words, depending on the functional classification, a module may be a part of a component, a device, an apparatus, a system, and/or the like wherein the module may be coupled to or integrated with other parts of the component, device, apparatus, or system such that the combination thereof forms the component, device, apparatus, or system. Alternatively, a module may be implemented as a standalone component, device, apparatus, system, and/or the like. Moreover, depending on the functional classification, a component, device, apparatus, system, and/or the like may be a part of a module of another component, device, system, and/or the like.

In various embodiments, a module may be a hardware structure such as a circuitry implemented using technologies such as electrical and/or optical technologies (and with more specific examples of semiconductors) for performing defined operations or functions. A module may alternatively refer to the combination of a hardware structure and a software structure, wherein the hardware structure may be implemented using technologies such as electrical and/or optical technologies (and with more specific examples of semiconductors) in a general manner for performing defined operations, functions, processes, or procedures according to the software structure in the form of a set of instructions stored in one or more non-transitory, computer-readable storage devices or media. Yet alternatively, a module may be a software structure that may be performed by any suitable hardware for performing defined operations, functions, processes, or procedures.

Herein, a process or procedure has a general meaning equivalent to that of a method, and does not necessarily correspond to the concept of computing process (which is the instance of a computer program being executed). More specifically, a process or procedure herein is a defined method implemented using hardware components for process data. A process or procedure may comprise or use one or more functions for processing data as designed. Herein, a function is a defined sub-process or sub-method for computing, calculating, or otherwise processing input data in a defined manner and generating or otherwise producing output data.

As those skilled in the art will appreciate, a process or procedure may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. A module may read the computer-executable code from the storage devices and execute the computer-executable code to perform the process.

Alternatively, a process or procedure may be implemented as one or more hardware structures having necessary electrical and/or optical components, circuits, logic gates, integrated circuit (IC) chips, and/or the like.

### B. Methods for Collaboration Between DCCs and Game Engines

The computer network system 100 may be used in online gaming, wherein the client computing-device 106 may be used as a digital content creator (DCC) and/or a game engine. Herein, a DCC refers to a three-dimensional (3D) computer-graphics software tool for creating various 3D models. Herein, “3D” refers to the three spatial dimensions of width, height, and depth. The physical world and everything that is observed therein are three-dimensional.

A game engine refers to a 3D computer-graphics software tool for rendering 3D scenes based on the 3D models provided by the DCC.

Herein, a 3D model (also denoted a “3D asset”) refers to a digital model having one or more digital objects (also denoted “contents”) such as 3D objects, animated films, visual effects, art, motion graphics, interactive 3D applications, virtual reality, and/or the like, arranged in one or more layers. When a 3D model comprises a plurality of layers, the layers may be arranged in one or more levels such that a higher-level layer may comprise zero, one, or more lower-level layers. A lower-level layer comprised in a higher-level layer may be denoted as a “sublayer” of that higher-level layer.

A 3D scene refers to an image or a video stream rendered or otherwise obtained from a 3D model. A 3D scene is suitable for being displayed to the user via a graphic user interface (GUI) on the client computing-device 106.

A user interface (UI) refers to the hardware and software by which the user and a computing device interact, in particular the use of input devices and software. A GUI refers to a visual way of interacting with a computing device using graphic items such as windows, icons, menus, and/or the like. A UI or a GUI may be a web user interface, which allows a user to interact with software and other content running through a web browser.

As those skilled in the art will understand, 3D models (and in turn, 3D scenes) sharing and collaboration is important in online gaming. Various technologies may be used in the computer network system 100 for 3D-model sharing and collaboration. For example, multi-layer video file formats have been used for video coding purposes. There are also systems and methods in prior art for electronic data file importation purposes. Moreover, there are frameworks in prior art for performing graphics animation and compositing operation, which is used as part of graphic-rendering process with communication of graphics-overlay information (in the context of videos only).

There also exist systems in prior art for transmitting graphics commands between multiple display devices and interfaces. However, such systems are not for transmitting shared 3D-model files between DCCs and game engines.

There are methods and systems for networking synchronization between different computer terminals, and between computer terminals and cloud servers. However, such methods and systems are used in the field of augmented reality, and are different from synchronization of 3D-model files between DCCs and game engines.

Thus, at least most of the prior-art methods and systems are not related to data communication and collaboration between DCCs and game engines.

In the following, methods of collaboration between DCCs and game engines are described. The methods provide solutions for solving one or both of the following challenges:
1. Data sharing may take a long time during movies and games creation, and may have to be done manually, thereby causing unsatisfactory experiences to users.
2. Collaboration in online gaming is usually inefficient as it may take many steps to set up the environment, prepare 3D assets, and adjust the 3D scenes as a team.

FIG. 4 is a schematic diagram showing the function structure 180 of the computer network system 100 for 3D-model sharing and collaboration between DCCs and game engines. As shown, from the functional point of view, the computer network system 100 comprises one or more data-storage servers 182, one or more broadcast servers 184, one or more user interface (UI) or graphic user interface (GUI) endpoints 186, one or more DCCs 188, and one or more game engines 190. The GUI endpoints 186, DCCs 188, and game engines 190 may be generally denoted “endpoints”.

The data-storage server 182 may run in one or more server computers 102 and store a variety of 3D-models in the form of a plurality of files (described in more detail later). The data-storage server 182 may provide application programming interface (API, which is a software intermediary that allows two applications to talk to each other) to upload, download, create and delete files, as well as provide authentication mechanism protecting data stored. The 3D-model files stored in the data-storage server 182 may be managed in an architecture that maintains the information about each node (for example, a folder or a file; described in more detail later) in the data storage including but not limited to whether the node is a folder or file, the parent information of the node, children information of the node, and the file information.

The broadcast server 184 may run in one or more server computers 102 and process and transmit change actions and event data between DCCs 188 and game engines 190. It may also provide the service of connecting different endpoints in the same virtual spaces, or disconnecting the endpoint when the switch at the endpoints are turned off. Herein, the term “virtual space” refers to the phenomenon wherein multiple users logged-in on their respective end-points attempt to process the same 3D-model file concurrently. The term “switch” refers to the phenomenon of logging-in and establishing a session with the broadcast server 184 or logging out of the same.

Depending on the implementation, the data-storage server 182 and broadcast servers 184 may run in different server computers 102 or may run in the same server computer.

The GUI endpoint 186 may run in a client computing-device 106 and function as a virtual interface of the data-storage server 182 for displaying the architecture of 3D-model files, which may show the folders and files and their children. In relation to the GUI endpoint 186, user authentication may be required to protect the stored data, and APIs may be used for downloading, uploading, adding, and deleting the files and folders. An authenticated user may read the file content and edit the content by using the GUI endpoint 186, pushing changes to replace old content, and/or pulling the content from the data storage server 182 after the content is changed at other endpoints.

The DCC 188 and game engine 190 may run in a client computing-device 106. The method described can be implemented as an add-on or a plugin in the DCC 188 and/or game engine 190 such that users may login, display the list of 3D models and/or scenes stored in the data-storage server 182, and select the 3D models and/or scenes for displaying at the application scene. Other functionalities of the DCC 188 and game engine 190 may include (described in more detail later) pushing, pulling, turning on or off object-level or layer-level live-synchronization (live-sync), displaying the 3D-model data obtained from the data-storage server 182, turning on or off the push or pull flags for the plurality of layers for the 3D model scene, and/or the like. Herein, live-sync refers to the action of causing a set of data or files to remain identical in more than one location, in real time.

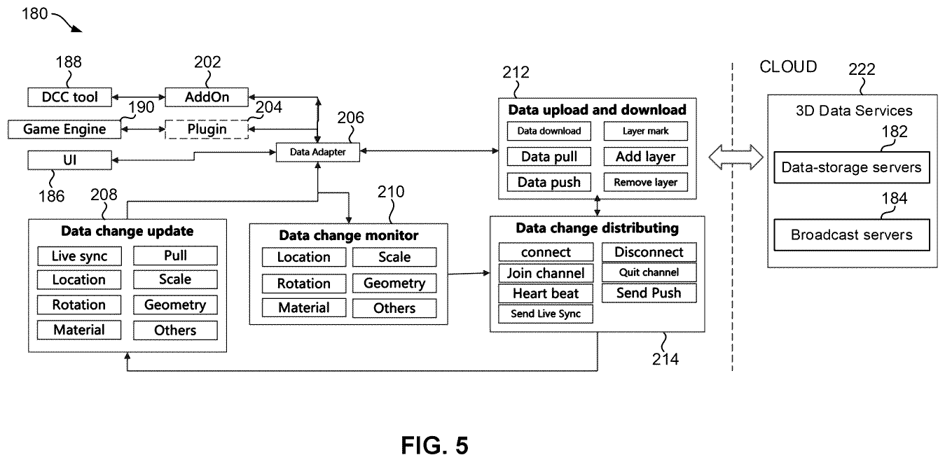

FIG. 5 is a schematic diagram showing the detailed functional structure 180 of the computer network system 100, according to some embodiments of this disclosure. As shown, the DCC 188 (in the form of an addon 202), game engine 190 (in the form of a plugin 204), and UI endpoint 186 interact with the 3D data service 222 (comprising the data-storage server 182 and the broadcast server 184) on the cloud via a data adapter 206 for performing a plurality of data operations including:
data change update 208 which includes actions such as updates for live-sync, location, rotation, material, pull, scale, geometry, and/or the like;
data change monitor 210 which includes actions such as monitoring of location, rotation, material, scale, geometry, and/or the like;
data upload and download 212 which includes actions such as data download, data pull, data push, layer mark, add layer, remove layer, and/or the like;
data change distributing 214 which includes actions such as connecting, disconnecting, joining a channel, quitting a channel, sending a heartbeat (which is a message sent periodically to keep the user session alive), sending a push, sending live-sync, and/or the like.

Actions of data change monitor 210 (for example, data change detected) and/or data upload and download 212 (for example, new content or changed content uploaded) may cause actions of data change distributing 214 which in turn triggers actions of data change update 208 (for example, sending data change updates to DCCs and game engines) and/or data upload and download 212 (for example, causing other DCCs/game engines to download new or changed content).

The methods and the systems employing same may utilize a suitable data structure of the 3D model that facilitates the communication between DCCs and game engines with various advantages such as:
(i) Decoupling with the underlying 3D model file data by separating the data of the 3D model into a plurality of parts (that is, a plurality of layers) such that the data of a layer may be independently modified without affecting other layers, thereby allowing a plurality of users to modify the same 3D-model file without conflicts;
(ii) Efficient data structure that allows sub-layering recursively; and
(iii) Minimizing the size of the 3D-model files.

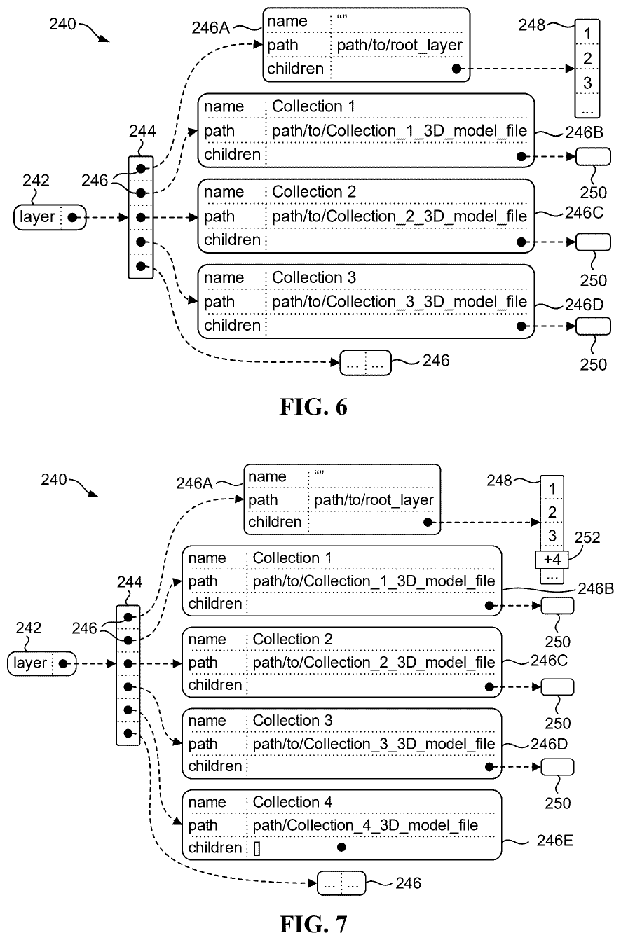

FIG. 6 is a schematic diagram showing the data structure 240 of a 3D model according to some embodiments of this disclosure, wherein the broken-line arrows point to the details of the fields indicated by the corresponding starting dots. In these embodiments, the data structure 240 of the 3D model comprises a plurality of 3D-model files including a root file and a set of one or more data files (also denoted “facilitating files”). Each set of data files of the 3D model corresponds to a layer of the 3D model and comprises data thereof. More specifically, a facilitating file of a 3D model may be a template format file of the 3D model, a file of additional linked assets including, but not limited to, materials and textures, or the like.

As shown in FIG. 6, the root file comprises a layer field 242 for storing an array 244 of informative data items 246 (including 246A to 246D) of the layers of the 3D model. Each informative data item 246 comprises a plurality of fields such as a name field for specifying the name of the layer, a path field for specifying the reference path to the native data (such as one or more 3D model template files) associated with the corresponding layer, and a children field for specifying the sublayers thereof.

In the example shown in FIG. 6, the informative data item 246A has an empty name field, a path field with a file path pointing to “path/to/root_layer”, and a children field having an array 248 of references (such as indices, pointers, or the like) pointing or otherwise linking to the informative data items of the sublayers thereof.

Each of the three informative data items 246B to 246D has a name field having the respective name “Collection 1”, “Collection 2”, or “Collection 3”; a path field having the respective file path “path/to/Collection_1_3D_model_file”, “path/to/Collection_2_3D_model_file”, or “path/to/Collection_3_3D_model_file”; and an empty children field 250 meaning that it has no sublayer.

In these embodiments, the 3D model may comprises a root layer, which may be indicated in the root file by using, for example, a special name such as “root_layer” or an empty name in the name field of the corresponding informative data item. The native data associated with the root layer may be added to the root of the 3D scene.

In the example shown in FIG. 6, the informative data item 246A has an empty name field, thereby indicating that it is the root layer. The children field of the informative data item 246A has references 248 pointing or otherwise linking to the three layers 246B to 246D, meaning that the three layers 246B to 246D are top-level layers and are sublayer of the root layer 246A.

FIG. 7 is a schematic diagram showing the add-layer operation for adding a new top-level layer “Collection 4” to the root layer 246A of the data structure 240 of a 3D model, according to some embodiments of this disclosure. As shown, the informative data item 246E of the new layer “Collection 4” is added to the array 244 of the layer field 242 of the root file. The reference 252 of the new layer 246E is also added to the array 248 of the children field of the root layer 246A.

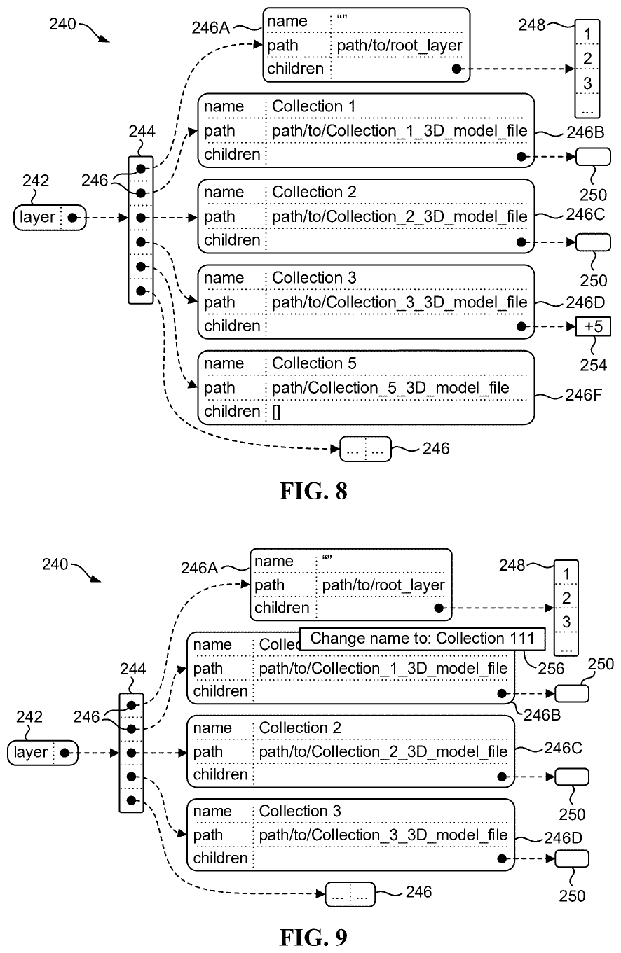

FIG. 8 is a schematic diagram showing the add-sublayer operation for adding a new layer “Collection 5” to the layer 246D of the data structure 240 of a 3D model, according to some embodiments of this disclosure. As shown, the informative data item 246F of the new layer “Collection 5” is added to the array 244 of the layer field 242 of the root file. The reference 254 of the new layer 246F is added to the array of the children field of the layer 246D.

The add-sublayer operation may also be used for adding a new layer to a sublayer.

FIG. 9 is a schematic diagram showing the rename-layer operation for renaming an existing layer 246B of the data structure 240 of a 3D model, according to some embodiments of this disclosure. As shown, in responding to an instruction 256, the value of the name field of the layer 246B may be changed from “Collection 1” to “Collection 111”.

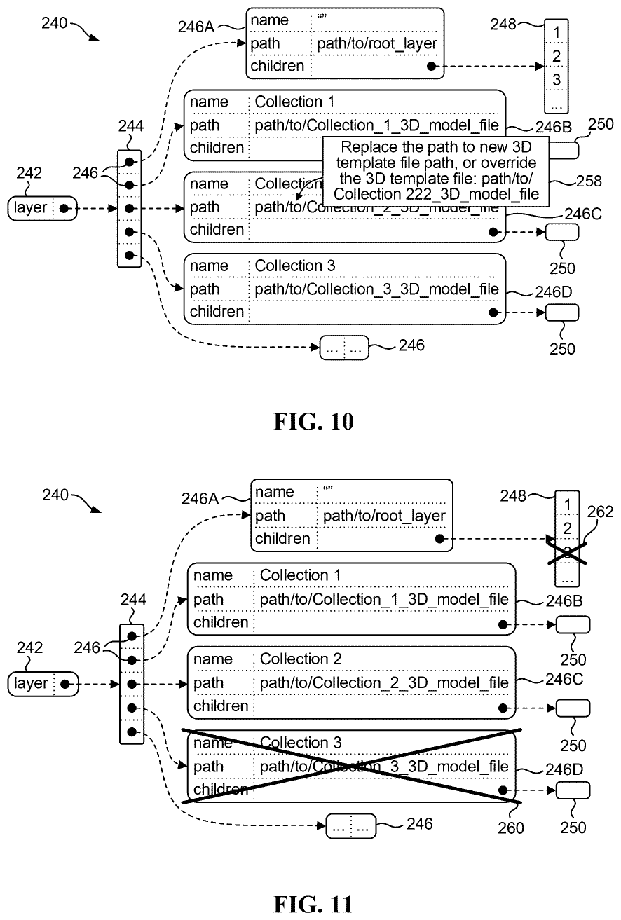

FIG. 10 is a schematic diagram showing the edit-layer operation for editing the informative data item (such as the path field) of an existing layer 246C of the data structure 240 of a 3D model, according to some embodiments of this disclosure. As shown, in responding to an instruction 258, the value of the path field of the layer 246C may be changed from “path/to/Collection_2_3D_model_file” to the path “path/to/Collection 222_3D_model_file” of a new 3D template file.

FIG. 11 is a schematic diagram showing the delete-layer operation for deleting an existing layer 246D of the data structure 240 of a 3D model, according to some embodiments of this disclosure. As shown, the informative data item of the layer 246D is deleted (indicated by the cross 260) and the reference in the children field of the parent layer (which in this example is the root layer 246A) is also deleted (indicated by the cross 262).

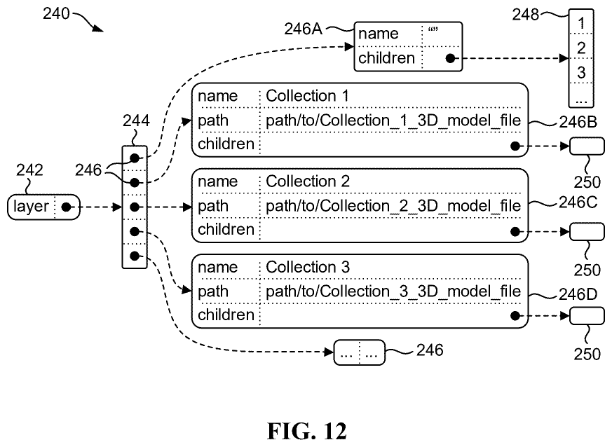

In some embodiments, a 3D model may not comprise a root layer. As shown in FIG. 12, the data structure 240 of the 3D model may comprise an informative data item 246A of a nominal root-layer, which may not comprise a path field, and, for example, only comprises the name field and the children field.

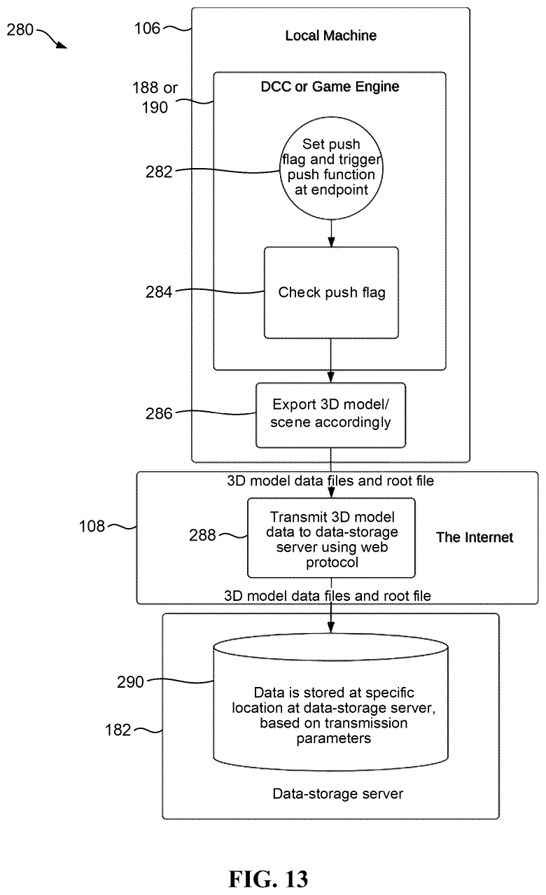

FIG. 13 is a flowchart showing the workflow of the push operation 280 for sending a 3D model from a client computing-device 106 (also denoted a “local machine”, which may run a DCC 188 or a game engine 190) to the data-storage server 182. In these embodiments, the 3D model in the local machine 106 is associated with a push flag for indicating whether the 3D model is to be pushed to the data-storage server 182. At step 282, a user of the DCC 188 or game engine 190 may set the push flag of the 3D model to start the push operation. Alternatively, an editing operation to the 3D model may also trigger the push flag being set.

The DCC 188 or a game engine 190 checks the push-flag status of the 3D models in the local machine 106 (step 284). If the push flag of a 3D model is set, the DCC 188 or a game engine 190 exports the 3D model (step 286) and uploads it (including the root files and 3D model template files thereof) to the data-storage server 182 via the network 108 using, for example, suitable web protocol (step 288). The data of the 3D model is then stored at specific location at the data-storage server 182 based on transmission parameters (such as parameters indicating one or more paths for storing the data of the 3D model as one or more files) (step 290). After the push operation 280, the uploaded 3D model is ready to be downloaded or pulled by other DCC or game engine endpoints 188 or 190.

In some embodiments, each layer of a 3D model may be associated with a push-layer flag for indicating whether the layer of the 3D model is to be pushed to the data-storage server 182 (similar to the push flag described above). The push operation for the layer is similar to the push operation 280 shown in FIG. 13.

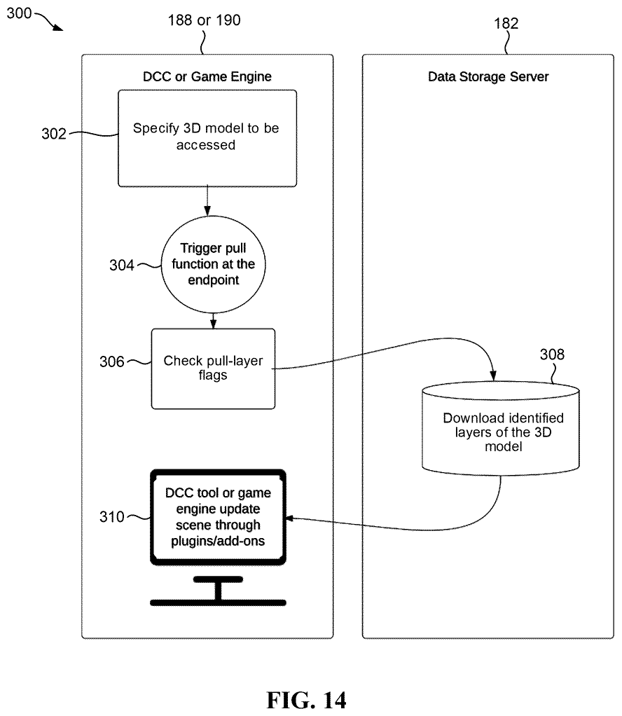

FIG. 14 is a flowchart showing the workflow of the pull operation 300 for downloading a 3D model from the data-storage server 182. The pull operation 300 may be used as a standalone operation or as a part of the object live-sync and layer live-sync operations.

In these embodiments, each layer of a 3D model may comprise a pull-layer flag for indicating whether the layer needs to be pulled from the data-storage server 182. As shown in FIG. 14, the user of a DCC 188 or game engine 190 may specify the 3D model to be accessed (that is, to be downloaded from the data-storage server 182) (step 302). Then, a pull trigger is triggered (step 304), and the DCC 188 or game engine 190 checks the pull-layer flags to identify the layers of the specified 3D model to be downloaded (step 306). Then, the DCC 188 or game engine 190 communicates with the data-storage server 182 to download the identified layers of the specified 3D model (step 308). After downloading, the DCC 188 or game engine 190 may update the specified 3D model and/or the corresponding 3D scene using the downloaded layers through, for example, the plugins/addons (step 310).

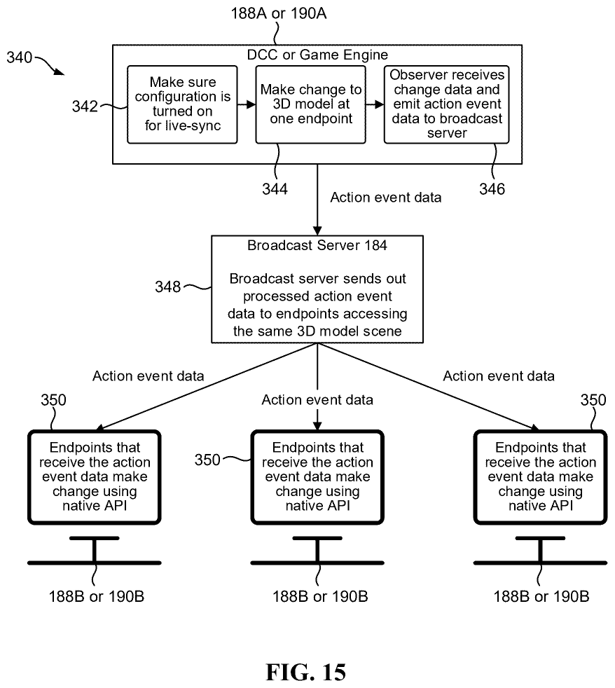

FIG. 15 is a flowchart showing the workflow of the object-level live-sync operation 340 for synchronizing a digital object of a 3D model in real-time. The object-level live-sync operation 340 may be used when a plurality of users are editing and/or using the same 3D model at the same time.

At step 342, the user of the DCC 188A or game engine 190A first selects the 3D model, and then turn on the object-level live-sync configuration. Then, the user of the DCC 188A or game engine 190A may make changes to a digital object of the 3D model (such as changes to the position, geometry, materials, and/or the like of the digital object) (step 344).

The DCC 188A or game engine 190A may comprise an endpoint observer for “listening” or otherwise monitoring the changes or updates made to the 3D model (or more specifically, the digital objects thereof) and, once changes or updates of a digital object are detected, uploading the changed or updated digital object of the 3D model to the data-storage server 182, and emitting an action event to the broadcast server 184 (step 346). The broadcast server 184 may broadcast a notification to other endpoints (that is, other DCCs 188B and/or game engine 190B) (step 350). The endpoints 188B and/or 190B receiving the broadcast may download the digital object of the 3D model and incorporate it into their local copies of the 3D model using the native API.

Those skilled in the art will appreciate that, in other embodiments, the object-level live-sync operation 340 may also be used for live-synchronization of a plurality of digital objects of a 3D model, or for live-synchronization of digital objects of a plurality of 3D models.

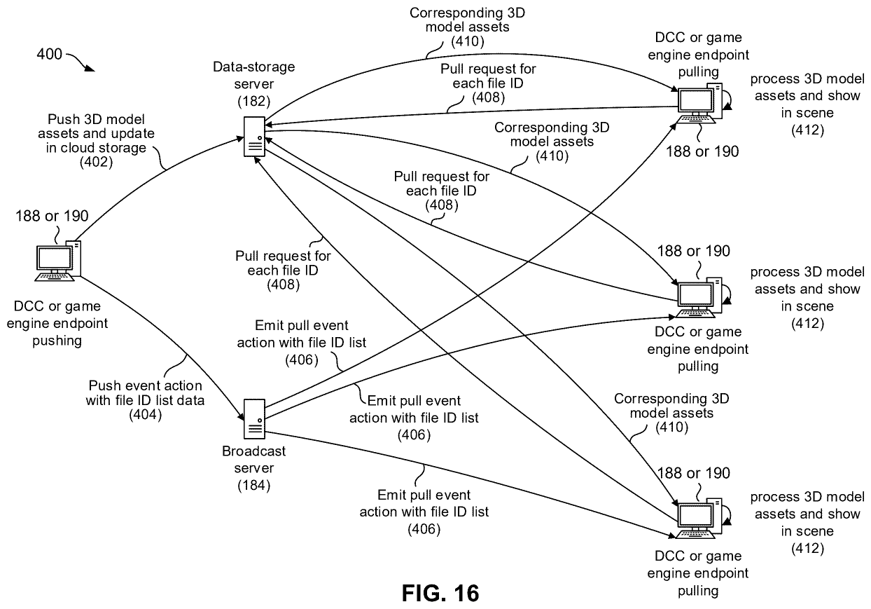

FIG. 16 is a flowchart showing the workflow of the layer-level live-sync operation 400 for synchronizing one or more layers of a 3D model in real-time. The layer-level live-sync operation 400 may be used when a plurality of users are editing and/or using the same 3D model at the same time.

At step 402, the user of the DCC 188A or game engine 190A may select a 3D model, turn on the layer-level live-sync configuration, turn on the push-layer flags associated with one or more layers to be pushed, and then triggers the push operation to upload the one or more layers of the 3D model to the data-storage server 182 using the push operation 280 described above. At step 404, the endpoint 188A or 190A may perform a push-event action to the broadcast server 184 with the file identifiers (ID) of the one or more layers of the 3D model and related information such as the names or IDs of the one or more layers. Then, the broadcast server 184 may transmit a pull action event with the file IDs and related information of the one or more layers (such as one or more updated layers or new layers) of the 3D model to other endpoints 188B and/or 190B (step 406). In response, the endpoints 188B and/or 190B may transmit a pulling request to the data-storage server 182 for each file ID of the one or more layers of the 3D model (step 408), and then download the files of the requested one or more layers of the 3D model from the data-storage server 182 using the pull operation 300 described above (step 410). At step 412, each endpoint 188B or 190B may update the 3D model in their local machine using the received one or more layers thereof, and show the updated 3D model.

As described above, in some embodiments, the data-storage server 182 and broadcast server 184 may run in the same server computer. Once step 402 is completed, the data-storage server 182 may notify the broadcast server 184 to perform step 406. In some embodiments, the data-storage server 182 and broadcast server 184 may be combined into the same server program (denoted data-storage/broadcast server). In these embodiments, once steps 402 and 404 are completed, the data-storage/broadcast server may then perform step 406.

The methods disclosed herein may be used for collaboration between any suitable DCCs 188 and game engines 190, including those existing in prior art, for enabling interactions therebetween. As will be described in more detail below, such interactions may include push (update 3D model (or more specifically, data of the 3D model) on the data-storage server 182), pull (extract 3D model data from the data-storage server 182), object-level live-sync (when a user edits and changes a 3D model in a DCC 188 or game engine 190, a plurality of other DCCs and/or game engines may receive the change and update accordingly), layer-level live-sync (the live-sync update is done on the layer level at a plurality of DCCs 188 and/or game engines 190).

In above embodiments, step 286 of the push operation 280 involves exporting the 3D model to upload it to the data-storage server 182. The purpose of exporting is to convert the 3D model to a format suitable for uploading to and storing in the data-storage server 182 and for other DCCs 188 and/or game engines 190 to use. In some embodiments, all DCCs 188 and game engines 190 may use a same format of 3D models suitable for uploading to and storing in the data-storage server 182, and thus, step 286 of the push operation 280 does not need to export the 3D model.

In some embodiments, a plurality of DCCs 188 may edit a same 3D model at the same time and use the object-level live-sync to synchronize the 3D model therebetween. In these embodiments, the DCCs 188 use the same format of the 3D model and thus may not need to export the 3D model during live-sync.

In some embodiments, a plurality of DCCs 188 may edit a same 3D model at the same time and each of the DCCs 188 may control a respective layer of the 3D model. Then, the plurality of DCCs 188 may use layer-level live-sync to synchronize the edited layers therebetween in real-time.

In some embodiments, a DCC 188 may edit a layer of a 3D model. When the editing is completed, the DCC 188 may push the layer to the data-storage server 182 and notify other DCCs 188 and/or game engines 190 to pull the layer of the 3D model.

In some embodiments, a plurality of game engines 190 may edit a same 3D model at the same time and use the object-level live-sync to synchronize the 3D model therebetween. In these embodiments, the game engines 190 use the same format of the 3D model and thus may not need to export the 3D model during live-sync.

In some embodiments, a plurality of game engines 190 may use layer-level live-sync to synchronize a 3D model therebetween and show the edits made to layers of the 3D model by other endpoints immediately, thereby reducing the time for exporting, transferring, and importing the 3D model.

In some embodiments, a game engine 190 may edit a layer of a 3D model. When the editing is completed, the game engine 190 may push the layer to the data-storage server 182 and notify other DCCs 188 and/or game engines 190 to pull the layer of the 3D model.

In some embodiments, a DCC 188 or a game engine 190 may edit a 3D model and push it to the data-storage server 182. Then, other DCCs 188 and/or game engines 190 may pull the updated 3D model and further edit it.

In some embodiments, a plurality of DCCs 188 and/or game engines 190 may use layer-level live-sync to collaborate therebetween such that the DCCs 188 and/or game engines 190 may edit, synchronize, and display a 3D model and the edits made thereto in real-time.

In some embodiments, a plurality of DCCs 188 and/or game engines 190 may use object-level live-sync to collaborate therebetween such that they may edit a 3D model at the same time until all users thereof are satisfied.

The computer network system 100 and the collaboration methods disclosed herein may be used for live-sync between a plurality of DCCs 188 and/or game engines 190 with increased production efficiency of digital arts. More specifically, the computer network system 100 and the collaboration methods disclosed herein may provide many benefits such as:
By using the live-sync methods disclosed herein, transformations made to a 3D model such as translation, scaling, rotating, stretching, skewing, adding, deleting, material changes, texture changes, and/or the like made to one or more objects vertices, edges, faces, and/or the like of the 3D model may be automatically synchronized among the DCCs 188 and/or game engines 190 in real time. Such a live-sync may be built from its atomic level of translating, scaling, rotating of the object or objects, the vertices, edges, faces, or changing the material and texture, to a more augmented operation, thereby reducing manual operations of transferring 3D models while achieving real-time updating of the 3D models at different endpoints.
By using the above-described data structure (using a root file and a plurality of 3D model template files), live synchronization may be achieved in a multi-layered fashion. As data of each layer may be stored separately (for example, in a separate 3D model template file) while the information of the 3D model is stored in a centralized location (for example, in the root file), the editing made by different users may be well separated by letting each user edit a separate layer, thereby facilitating multiuser collaboration on the same 3D model.
The push and pull operations and the push and pull flags disclosed herein may allow collaboration to be done asynchronously while having the option of synchronous collaboration using live-sync. The push and pull flags may disallow changes to be made to the same layer at the same time, thereby preventing ambiguity that may otherwise occur.

Although embodiments have been described above with reference to the accompanying drawings, those of skill in the art will appreciate that variations and modifications may be made without departing from the scope thereof as defined by the appended claims.

1. A method comprising:
receiving data of at least one first layer of a three-dimensional (3D) model;
broadcasting notification to one or more computing devices for notifying the one or more computing devices an update of the 3D model;
receiving a pull request from at least one of the one or more computing devices for pulling the at least one first layer of the 3D model; and
sending the entire 3D model or the at least one first layer thereof to the at least one of the one or more computing devices.

2. The method of claim 1, wherein the 3D model comprises:
at least one first file associated with the at least one first layer; and
a second file comprising information of the at least one first layer and the at least one first file.

3. The method of claim 2, wherein the information of the at least one first layer comprises:
a name of the at least one first layer and a path of the at least one first file;
wherein the second file further comprises information of a second layer; and
wherein the information of the second layer comprises:
a name of the second layer, and
at least one reference pointing to the at least one first layer.

4. The method of claim 1, wherein the 3D model comprises:
one or more third layers associated with the at least one first layer;
wherein the information of the at least one first layer comprises:
one or more references each pointing to a respective third layer; and
wherein the information of the second layer comprises:
one or more names of the one or more third layers, and
one or more paths pointing to one or more third files associated with the one or more third layers.

5. One or more processors for executing instructions stored in one or more non-transitory computer-readable storage devices to perform the method of claim 1.

6. The one or more processors of claim 5, wherein the 3D model comprises:
at least one first file associated with the at least one first layer,
a second file comprising information of the at least one first layer, information of the at least one first file, and information of a second layer, and
one or more third layers associated with the at least one first layer;
wherein the information of the at least one first layer comprises:
a name of the at least one first layer, a path of the at least one first file, and one or more references each pointing to a respective third layer;
wherein the information of the second layer comprises a name of the second layer and at least one reference pointing to the at least one first layer; and
wherein the information of the second layer comprises one or more names of the one or more third layers, and one or more paths pointing to one or more third files associated with the one or more third layers.

7. One or more non-transitory computer-readable storage devices comprising computer-executable instructions, wherein the instructions, when executed, cause one or more processors to perform the method of claim 1.

8. The one or more non-transitory computer-readable storage devices of claim 7, wherein the 3D model comprises:
at least one first file associated with the at least one first layer; and
a second file comprising information of the at least one first layer and the at least one first file.

9. The one or more non-transitory computer-readable storage devices of claim 8, wherein the information of the at least one first layer comprises:
a name of the at least one first layer; and
a path of the at least one first file.

10. The one or more non-transitory computer-readable storage devices of claim 9, wherein the second file further comprises information of a second layer; and
wherein the information of the second layer comprises:
a name of the second layer, and
at least one reference pointing to the at least one first layer.

11. The one or more non-transitory computer-readable storage devices of claim 10, wherein the 3D model comprises:
one or more third layers associated with the at least one first layer;
wherein the information of the at least one first layer comprises:
one or more references each pointing to a respective third layer; and
wherein the information of the second layer comprises:
one or more names of the one or more third layers, and
one or more paths pointing to one or more third files associated with the one or more third layers.

12. A method comprising:
storing information of a first layer of a three-dimensional (3D) model into a root file as a first informative data item; and
storing, in a root informative data item of the root file, a first reference pointing to the first informative data item;
wherein the first informative data item comprises:
a name of the first layer, and
a path of a first file associated with the first layer.

13. The method of claim 12 further comprising:
storing information of a second layer of a three-dimensional (3D) model into the root file as a second informative data item; and
storing, in the first informative data item, a second reference pointing to the second informative data item;
wherein the second informative data item comprises:
a name of the second layer, and
a path of a second file associated with the second layer.

14. The method of claim 12 further comprising:
changing the name of the first layer in the first informative data item;
changing, in the first informative data item, the path of the first file associated with the first layer;
removing the first informative data item from the root file and removing the first reference from the root informative data item of the root file;
determining that a push flag of a target is set, the target being the 3D model or the first layer of the 3D model, and transmitting the target to a computing device;
determining that a pull flag of the first layer of the 3D model is set, downloading a third file from a computing device, and changing, in the first informative data item, the path of the first file to a path of the third file; or
a combination thereof.

15. One or more processors for executing instructions stored in one or more non-transitory computer-readable storage devices to perform the method of claim 12.

16. The one or more processors of claim 15, wherein the method further comprises:
storing information of a second layer of a three-dimensional (3D) model into the root file as a second informative data item; and
storing, in the first informative data item, a second reference pointing to the second informative data item;
wherein the second informative data item comprises:
a name of the second layer, and
a path of a second file associated with the second layer.

17. The one or more processors of claim 16, wherein the method further comprises:
changing the name of the first layer in the first informative data item;
changing, in the first informative data item, the path of the first file associated with the first layer;
removing the first informative data item from the root file and removing the first reference from the root informative data item of the root file;
determining that a push flag of a target is set, the target being the 3D model or the first layer of the 3D model, and transmitting the target to a computing device;
determining that a pull flag of the first layer of the 3D model is set, downloading a third file from a computing device, and changing, in the first informative data item, the path of the first file to a path of the third file; or
a combination thereof.

18. One or more non-transitory computer-readable storage devices comprising computer-executable instructions, wherein the instructions, when executed, cause one or more processors to perform the method of claim 12.

19. The one or more non-transitory computer-readable storage devices of claim 18, wherein the method further comprises:
storing information of a second layer of a three-dimensional (3D) model into the root file as a second informative data item; and
storing, in the first informative data item, a second reference pointing to the second informative data item;
wherein the second informative data item comprises:
a name of the second layer, and
a path of a second file associated with the second layer.

20. The one or more non-transitory computer-readable storage devices of claim 19, wherein the method further comprises:
changing the name of the first layer in the first informative data item;
changing, in the first informative data item, the path of the first file associated with the first layer;
removing the first informative data item from the root file and removing the first reference from the root informative data item of the root file;
determining that a push flag of a target is set, the target being the 3D model or the first layer of the 3D model, and transmitting the target to a computing device;
determining that a pull flag of the first layer of the 3D model is set, downloading a third file from a computing device, and changing, in the first informative data item, the path of the first file to a path of the third file; or
a combination thereof.
